(19) United States
(12) Patent Application Publication
(10) Pub. No.: US 2016/0016550 A1
(43) Pub. Date: Jan. 21, 2016

(54) END CAP DEVICE FOR A WIPER BLADE

(71) Applicant: Robert Bosch GmbH, Stuttgart (DE)

(72) Inventors: Helmut Depondt, Boutersem (BE); Dirk Herinckx, Dries-Linter (BE); Koen Bex, Jeuk/Limburg Belgien (BE)

(21) Appl. No.: 14/801,924

(22) Filed: Jul. 17, 2015

(30) Foreign Application Priority Data
Jul. 17, 2014 (DE) 10 2014 213 971.6

(51) Int. Cl. B60S 1/38

(52) U.S. Cl. CPC B60S 1/3887; B60S 1/3894; B60S 1/3879

(57) ABSTRACT

An end cap device for a wiper blade (10a), having a main end cap body (12a-12d) and having at least one wiper strip fastening means (14a; 14c; 14d) which is arranged on the main end cap body (12a-12d) and is intended for fixing the main end cap body (12a-12d) in a wiper strip longitudinal direction (16a; 16c; 16d) relative to a wiper strip (18a; 18c; 18d). The at least one wiper strip fastening means (14a; 14c; 14d) is configured to be deflectable in a vertical direction (20a; 20c; 20d) for assembly with the wiper strip (18a; 18c; 18d).

### BACKGROUND OF THE INVENTION

An end cap device for a wiper blade, having a main end cap body and having at least one wiper strip fastening means which is arranged on the main end cap body and is intended for fixing the main end cap body in a wiper strip longitudinal direction relative to a wiper strip, has already been proposed.

### SUMMARY OF THE INVENTION

The invention proceeds from an end cap device for a wiper blade, having a main end cap body and having at least one wiper strip fastening means which is arranged on the main end cap body and is intended for fixing the main end cap body in a wiper strip longitudinal direction relative to a wiper strip.

It is proposed that the at least one wiper strip fastening means is configured to be deflectable in a vertical direction for assembly with the wiper strip. As a result, the end cap device can be configured in a particularly compact manner. Furthermore, particularly secure coupling of the main end cap body to the wiper strip along with easy assembly can be achieved. Advantageously, the at least one wiper strip fastening means is configured to be movable in a direction away from the wiper strip during assembly. In this connection, a “main end cap body” should be understood as meaning in particular a body which substantially covers a free end of a wiper strip, of a spring rail and/or of a wind deflector unit, and/or forms an end of the wiper blade in a wiper blade longitudinal direction.

A “spring rail” should be understood as meaning in particular a macroscopic element which has at least one extent that is elastically variable by at least 10%, in particular by at least 20%, preferably by at least 30% and particularly advantageously by at least 50% in a normal operating state, and which in particular generates an opposing force dependent on a variation in the extent and preferably proportional to the variation, said opposing force counteracting the variation. Preferably, the spring rail is formed at least in part from spring steel. Preferably, the spring rail is in the form of a bent bar and particularly advantageously of a flattened bent bar in an unloaded state. Particularly advantageously, a curvature of the spring rail along a longitudinal extent in an unloaded state is greater than a curvature of a vehicle surface of the motor vehicle, in particular of a vehicle window over which the spring rail is guided in at least one operating state. An “extent” of an element should be understood as meaning in particular a maximum spacing between two points on a perpendicular projection of the element onto a plane. A “macroscopic element” should be understood as meaning in particular an element having an extent of at least 1 mm, in particular of at least 5 mm and preferably of at least 10 mm.

In this connection, a “wiper strip longitudinal direction” should be understood as meaning in particular a direction which extends at least substantially parallel to a main direction of extent of a straightened wiper strip. In this connection, a “wiper strip” should be understood as meaning in particular a strip which is intended to wipe a vehicle window. Preferably, the wiper strip is formed from rubber material. Advantageously, the wiper strip comprises a wiper lip, a tilting web, a squeegee strip and/or a head strip. In particular, “deflectable in a vertical direction” should be understood as meaning that a movement, necessary for coupling, of the at least one wiper strip fastening means takes place in the vertical direction. Preferably, a pivot axis extends parallel to the wiper strip longitudinal direction.

In this connection, a “vertical direction” should be understood as meaning in particular a direction which extends at least substantially perpendicularly to a vehicle window to be wiped. In particular, the vertical direction extends at least substantially perpendicularly to a wiping direction. Furthermore, the vertical direction extends at least substantially perpendicularly to the wiper strip longitudinal direction. The wiper strip longitudinal direction extends at least substantially perpendicularly to the wiping direction. In this connection, “at least substantially” should be understood as meaning in particular a deviation of less than 15°, preferably of less than 5°, particularly preferably of less than 1°. The term “intended” should be understood as meaning in particular specifically designed and/or equipped. The fact that an object is intended for a particular function should be understood as meaning in particular that the object fulfills and/or executes this particular function in at least one usage and/or operating state.

In a further configuration of the invention, it is proposed that the at least one wiper strip fastening means forms a spring rail abutment means which is intended to block the at least one wiper strip fastening means upon abutment of at least one spring rail. As a result, operational reliability can advantageously be increased. Preferably, the spring rail abutment means has an abutment surface remote from the wiper lip, said abutment surface being intended for the abutment of the spring rail. The abutment surface can be configured in a curved or advantageously planar manner.

It is furthermore proposed that the end cap device comprises at least one latching means which is arranged on the main end cap body and is intended to fix at least one further wiper blade component. As a result, coupling of the at least one further wiper blade component to the main end cap body which is particularly easy to establish can be achieved. In this connection, a “further wiper blade component” should be understood as meaning in particular a spring rail and/or a wind deflector unit. In this connection, a “latching means” should be understood as meaning in particular a spring-elastic means for establishing a latching connection, said means being intended to be elastically deflected during assembly. Preferably, the latching means is formed at least regionally in a barb-like manner.

In an additional configuration of the invention, it is proposed that the end cap device comprises at least two latching means which are arranged on the main end cap body and are intended to fix at least one further wiper blade component.

Furthermore, it is proposed that the at least one latching means is configured to be deflectable at least substantially perpendicularly to a deflection direction of the at least one wiper strip fastening means. As a result, independent deflection of the at least one latching means and of the at least one wiper strip fastening means can advantageously be achieved.

Furthermore, it is proposed that the at least one wiper strip fastening means is connected to a side wall of the main end cap body. As a result, the end cap device can be configured in a particularly stable and compact manner. Preferably, the at least one wiper strip fastening means is connected integrally to the side wall of the main end cap body. The term “integrally” should be understood as meaning in particular cohesively connected, for example by way of a welding process, an adhesive-bonding process, and injection process and/or some other process that appears appropriate to a person skilled in the art, and/or formed advantageously in one piece, for example by being produced from one casting and/or by being produced in a one-component or multi-component injection-molding process and advantageously from a single blank. The side wall terminates the end cap preferably in the wiping direction.

Furthermore, it is proposed that the at least one latching means is arranged on a side wall of the main end cap body. As a result, the end cap device can be configured in a particularly stable and compact manner.

Furthermore, it is proposed that the spring rail abutment means of the at least one wiper strip fastening means forms an extension of a spring rail abutment surface of the main end cap body. As a result, increased internal stability of the end cap device can be achieved.

Also proposed is a system having an end cap device and having at least one spring rail which is intended to block the at least one wiper strip fastening means in an assembled state. As a result, particularly high operational reliability can be achieved.

It is furthermore proposed that the spring rail has at least one latching recess which is intended for coupling with the at least one latching means. As a result, particularly quick and secure coupling of the spring rail to the latching recess can be achieved.

Furthermore, it is proposed that the system comprises a wiper strip which is intended to be coupled with the at least one wiper strip fastening means in an assembled state. As a result, slipping of the wiper strip in the wiper strip longitudinal direction during wiping operation can advantageously be reduced or avoided.

Particularly advantageously, a wiper blade has the system according to the invention.

The end cap device according to the invention is not intended to be restricted here to the above-described application and embodiment. In particular, the end cap device according to the invention can have a number of individual elements, components and units which differs from the number mentioned herein in order to fulfill a functionality described herein.

### BRIEF DESCRIPTION OF THE DRAWINGS

Further advantages can be gathered from the following description of the drawing. Four exemplary embodiments of the invention are illustrated in the drawing. The drawing, the description and the claims contain numerous features in combination. A person skilled in the art will expediently also consider the features individually and combine them to form appropriate further combinations.

In the drawing:

FIG. 1 shows a perspective view of a wiper blade having an end cap device in an assembled state,

FIG. 2 shows a front view of the end cap device according to FIG. 1,

FIG. 3 shows a perspective view of the wiper blade according to FIG. 1 prior to final assembly,

FIG. 4 shows a partial section of the end cap device during an assembly operation with the wiper blade,

FIG. 5 shows a further partial section of the end cap device during an assembly operation with the wiper blade,

FIG. 6 shows a perspective view of a spring rail,

FIG. 7 shows a sectional illustration of the spring rail according to FIG. 6 and the end cap device,

FIG. 8 shows a front view of a further exemplary embodiment of an end cap device,

FIG. 9 shows a perspective view of a further spring rail,

FIG. 10 shows a partial section of the end cap device according to FIG. 8 during an assembly operation with the wiper blade,

FIG. 11 shows a further partial section of the end cap device during an assembly operation with the wiper blade,

FIG. 12 shows a further partial section of the end cap device during an assembly operation with the wiper blade,

FIG. 13 shows a front view of a further exemplary embodiment of an end cap device,

FIG. 14 shows a perspective view of a further spring rail,

FIG. 15 shows a partial section of the end cap device according to FIG. 13 during an assembly operation with the wiper blade, and

FIG. 16 shows a partial section of the end cap device in an assembled state with the wiper blade.

### DETAILED DESCRIPTION

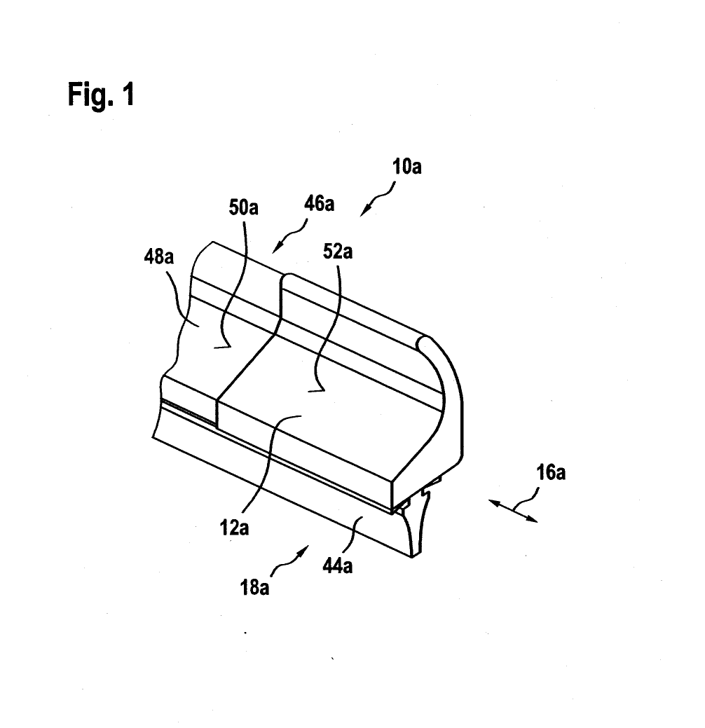

FIG. 1 shows a wiper blade 10a having an end cap device in an assembled state. The wiper blade 10a forms a flat wiper blade. The wiper blade 10a has a wiper strip 18a. The wiper strip 18a has a wiper lip 44a which is intended for wiping a vehicle window (not shown in more detail). The wiper strip 18a has been produced from a rubber material in an extrusion process. The wiper blade 10a also has a wind deflector unit 46a. The wind deflector unit 46a comprises a wind deflector element 48a. The wind deflector element 48a forms a concave wind deflection surface 50a which extends from the end cap device as far as a wiper blade adapter (not shown in more detail).

The end cap device has a main end cap body 12a. The main end cap body 12a is arranged on a free end of the wiper strip 18a. The main end cap body 12a has a concave wind deflection surface 52a. The main end cap body 12a terminates the wiper strip 18a and the wind deflector unit 46a in a wiper strip longitudinal direction 16a. The main end cap body 12a is formed from a plastics material.

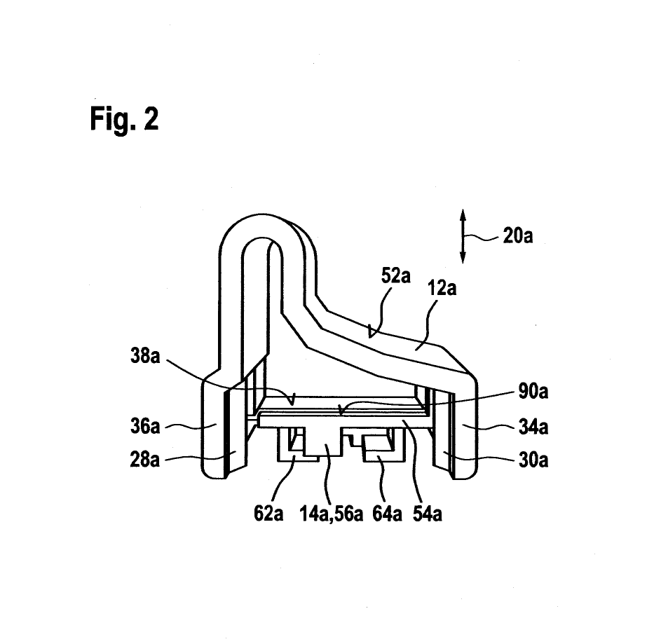

The end cap device is illustrated in more detail in FIG. 2. The end cap device has a wiper strip fastening means 14a. The wiper strip fastening means 14a is arranged on the main end cap body 12a. To be more precise, the wiper strip fastening means 14a is formed integrally with the main end cap body 12a. The wiper strip fastening means 14a is connected to a side wall 34a of the main end cap body 12a. To be more precise, the wiper strip fastening means 14a is connected integrally to the side wall 34a of the main end cap body 12a. Starting from the side wall 34a, the wiper strip fastening means 14a extends substantially in the direction of a further side wall 36a of the main end cap body 12a. The wiper strip fastening means 14a is intended to fix the main end cap body 12a in a wiper strip longitudinal direction 16a relative to the wiper strip 18a. In order to receive the wiper strip 18a, the end cap device has two holding claws 62a, 64a. A top side of the holding claws 62a, 64a forms a spring rail abutment surface 38a. In the assembled state, a spring rail 24a butts against the spring rail abutment surface 38a.

The wiper strip fastening means 14a has an elastically deflectable holding arm 54a. The holding arm 54a extends perpendicularly to the side wall 34a. The holding arm 54a has a rectangular cross section. Integrally formed on the holding arm 54a is an engagement element 56a. The engagement element 56a is formed in a cuboidal manner. The engagement element 56a is intended to engage in a corresponding head strip recess 58a in a head strip 60a of the wiper strip 18a. The wiper strip fastening means 14a is configured to be deflectable in a vertical direction 20a for assembly with the wiper strip 18a. To be more precise, the wiper strip fastening means 14a is configured to be movable in the direction of the wind deflection surface 52a during assembly. The wiper strip fastening means 14a is arranged in a manner offset in the wiper strip longitudinal direction 16a relative to the holding claws 62a, 64a. The wiper strip fastening means 14a is arranged in front of a receiving region of the holding claws 62a, 64a in an unstressed starting position. The vertical direction 20a extends perpendicularly to a wiping plane across which the wiper strip 18a scrapes during operation.

The end cap device also has two latching means 28a, 30a. The latching means 28a, 30a are formed regionally in a barb-like manner. The latching means 28a, 30a are arranged on the main end cap body 12a. To be more precise, the latching means 28a, 30a are arranged on the side walls 34a, 36a of the main end cap body 12a. The latching means 28a, 30a are intended to fix a further wiper blade component 26a. In this exemplary embodiment, the latching means 28a, 30a are intended to fix the wind deflector unit 46a. The latching means 28a, 30a are configured to be deflectable perpendicularly to a deflection direction 32a of the wiper strip fastening means 14a. To be more precise, the latching means 28a, 30a are configured to be displaceable in a wiping direction 82a. The latching means 28a, 30a are arranged in front of the wiper strip fastening means 14a, as viewed in an insertion direction 96a of the wiper strip 18a.

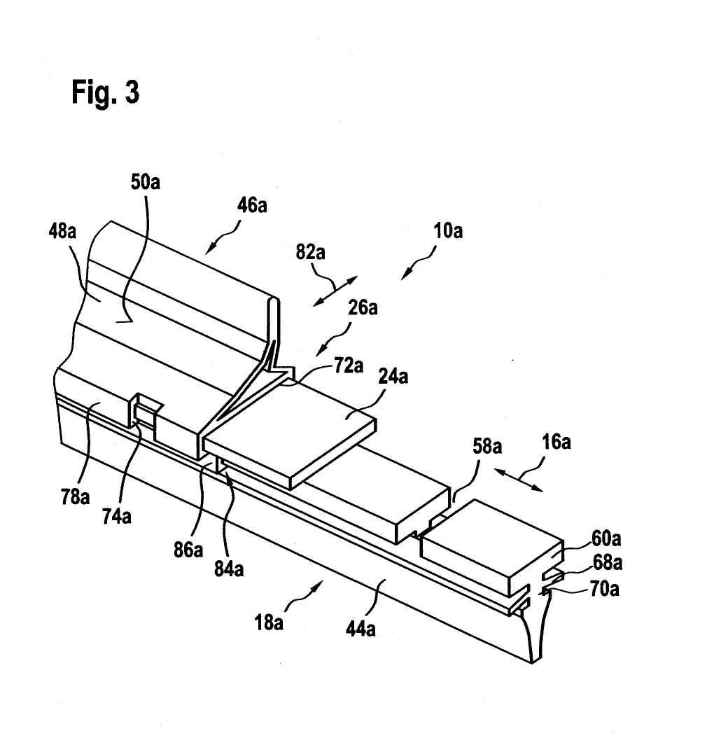

FIG. 3 shows the wiper blade 10a that is connectable to the end cap device, with a spring rail 24a. The wiper strip 18a has the head strip 60a and a squeegee strip 68a, which adjoin one another. Furthermore, the wiper strip 18a has a tilting web 70a. The wiper lip 44a is mounted in a pivotable manner relative to the head strip 60a via the tilting web 70a. The head strip recess 58a is arranged in an end region of the wiper strip 18a. To be more precise, the head strip recess 58a is arranged in a region of the wiper strip 18a which is covered by the main end cap body 12a in the assembled state.

The wind deflector unit 46a has a spring rail channel 72a. The spring rail channel 72a has an identical cross section to the spring rail 24a. The spring rail 24a is introducible into the spring rail channel 72a. The wind deflector unit 46a also has two latching recesses 74a, 76a which have been introduced into spring rail channel walls 78a, 80a. The latching recesses 74a, 76a pass all the way through the spring rail channel walls 78a, 80a and expose the spring rail channel 72a and the spring rail 24a introduced into the latter in the wiping direction 82a. Furthermore, the wind deflector unit 46a has a wiper strip guide 84a which is formed by laterally arranged holding claws 86a, 88a.

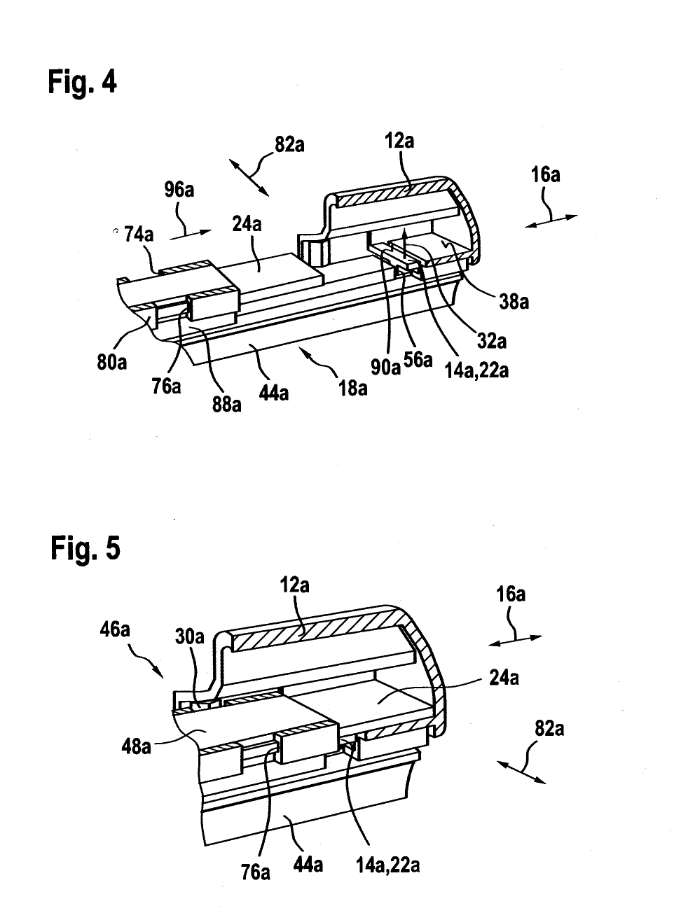

FIG. 4 shows only the spring rail channel 72a of the wind deflector unit 46a. The spring rail 24a projects regionally out of the spring rail channel 72a. The wiper strip 18a is inserted regionally into the wiper strip guide 84a. A part of the wiper strip 18a projects out of the wiper strip guide 84a. For assembly, the wiper strip fastening means 14a is deflected and pushed, together with the main end cap body 12a, over the head strip 60a. When the head strip recess 58a is reached, the wiper strip fastening means 14a moves elastically back into the starting position and in the process engages in the head strip recess 58a, as shown in FIG. 4. A free end of the wiper strip 18a is now held by the holding claws 62a, 64a of the end cap device. The wiper strip 18a is thus intended to be coupled with the wiper strip fastening means 14a in the assembled state.

The wiper strip fastening means 14a forms a spring rail abutment means 22a. The spring rail abutment means 22a is intended to block the wiper strip fastening means 14a upon abutment of the spring rail 24a. The spring rail abutment means 22a is formed integrally with the wiper strip fastening means 14a. To this end, the spring rail abutment means 22a forms an abutment surface 90a that is remote from the wiper lip. The abutment surface 90a is intended for the abutment of the spring rail 24a. The abutment surface 90a is formed in a planar manner. The spring rail abutment means 22a of the wiper strip fastening means 14a forms an extension of the spring rail abutment surface 38a of the main end cap body 12a.

In order to prevent the wiper strip fastening means 14a from pivoting back, the spring rail 24a is pushed over the spring rail abutment means 22a (FIG. 5). There, the spring rail 24a comes into abutment with the abutment surface 90a. The spring rail 24a is thus intended to block the wiper strip fastening means 14a in the assembled state. The wind deflector unit 46a is pushed into the end cap device until the latching means 28a, 30a of the end cap device engage in the latching recesses 74a, 76a. The wiper strip 18a is thus prevented from moving back from the main end cap body 12a.

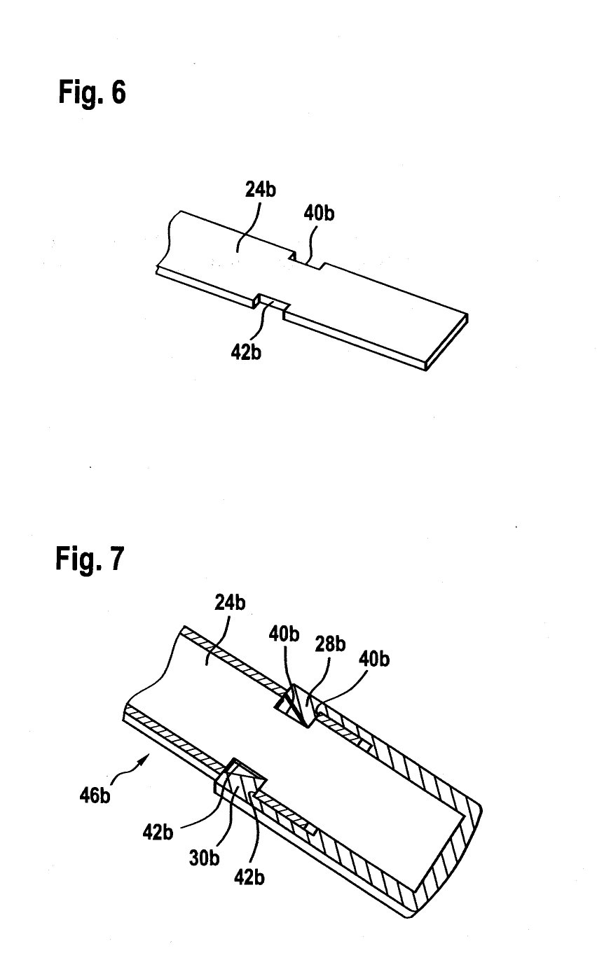

Three further exemplary embodiments of the invention are shown in FIGS. 6 to 16. The following descriptions and the drawings are limited essentially to the differences between the exemplary embodiments, it being possible to refer in principle also to the drawings and/or the description of the other exemplary embodiments, in particular FIGS. 1 to 5, with regard to identically designated components, in particular with regard to components having the same reference signs. In order to distinguish between the exemplary embodiments, the letter a is placed after the reference signs of the exemplary embodiment in FIGS. 1 to 5. In the exemplary embodiments in FIGS. 6 to 16, the letter a is replaced by the letters b to d.

The exemplary embodiment shown in FIGS. 6 and 7 corresponds substantially to the first exemplary embodiment. In contrast to the first exemplary embodiment, additional latching recesses 40b, 42b are arranged in the spring rail 24b. In FIG. 7, the spring rail 24 is coupled with the main end cap body 12b of the end cap device. The latching means 28b, 30b of the end cap device engage both in the latching recesses 74b, 76b in the wind deflector unit 46b and in the latching recesses 40b, 42b in the spring rail 24b.

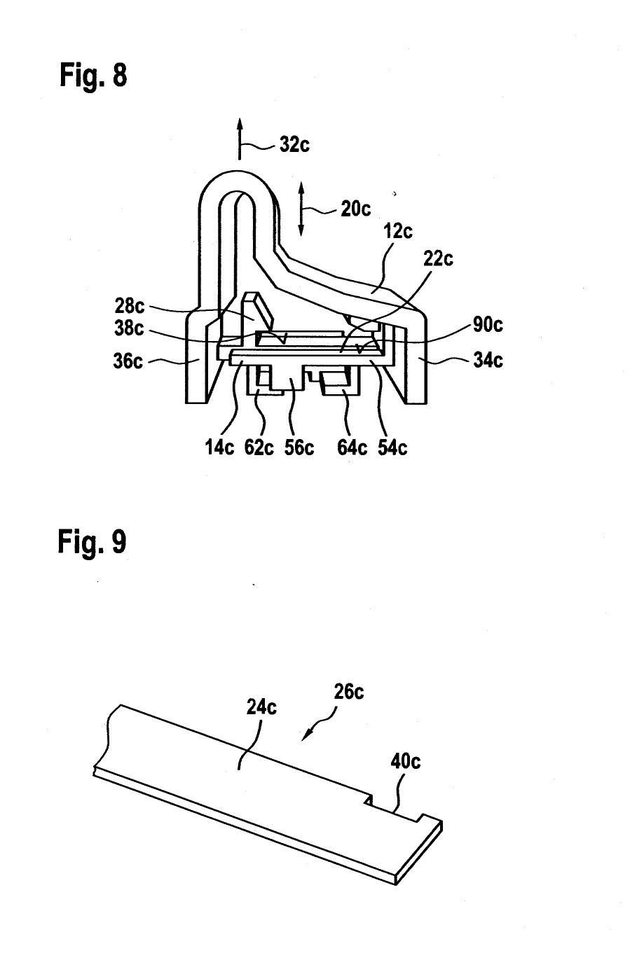

A further exemplary embodiment of the invention is shown in FIGS. 8 to 12. The end cap device has an alternatively configured main end cap body 12c (FIG. 8). The end cap device has a wiper strip fastening means 14c. The wiper strip fastening means 14c is arranged on the main end cap body 12c. To be more precise, the wiper strip fastening means 14c is configured integrally with the main end cap body 12c. The wiper strip fastening means 14c is connected to a side wall 34c of the main end cap body 12c. To be more precise, the wiper strip fastening means 14c is connected integrally to the side wall 34c of the main end cap body 12c.

Starting from the side wall 34c, the wiper strip fastening means 14c extends substantially in the direction of a further side wall 36c of the main end cap body 12c. The wiper strip fastening means 14c is intended to fix the end main end cap body 12c in the wiper strip longitudinal direction 16c relative to a wiper strip 18c. In order to receive the wiper strip 18c, the end cap device has two holding claws 62c, 64c. A top side of the holding claws 62c, 64c forms a spring rail abutment surface 38c. In the assembled state, a spring rail 24c butts against the spring rail abutment surface 38c. The spring rail 24c is shown in FIG. 9. The spring rail 24c has a latching recess 40c.

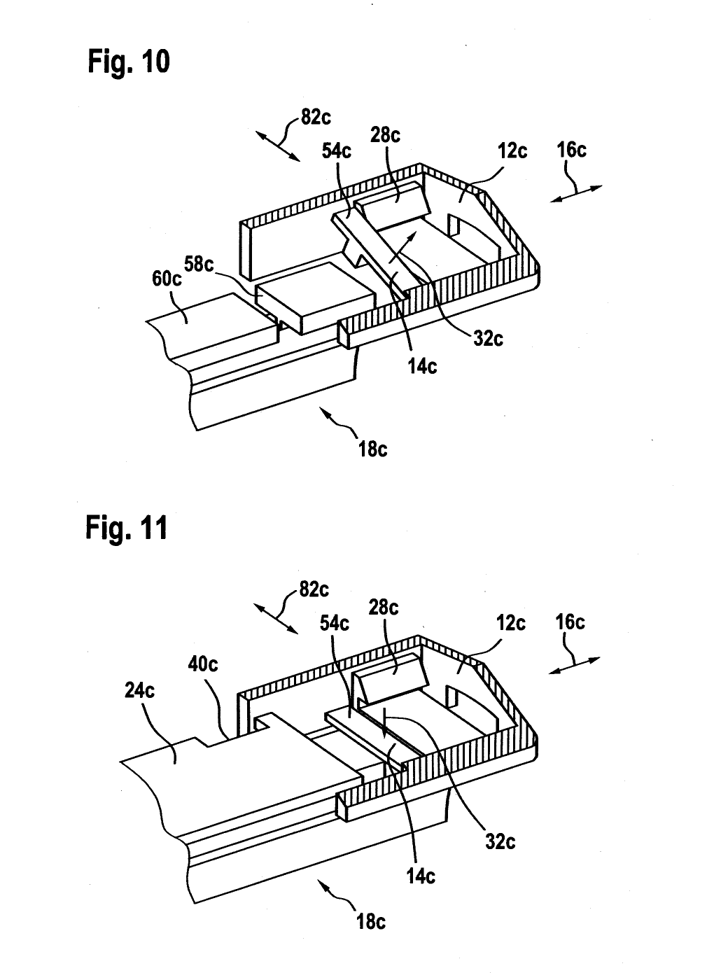

As shown in FIG. 10, the wiper strip fastening means 14c has an elastically deflectable holding arm 54c. The holding arm 54c extends perpendicularly to the side wall 34c in an unstressed state. In the figure shown, the holding arm 54c has been elastically deflected. The holding arm 54c has a rectangular cross section. Integrally formed on the holding arm 54c is an engagement element 56c. The engagement element 56c is formed in a cuboidal manner. The engagement element 56c is intended to engage in a corresponding head strip recess 58c in a head strip 60c of the wiper strip 18c. The wiper strip fastening means 14c is configured to be deflectable in a vertical direction 20c for assembly with the wiper strip 18c.

In contrast to the first exemplary embodiment, the end cap device has only one latching means 28c. The latching means 28c is formed regionally in a barb-like manner. The latching means 28c is arranged on the main end cap body 12c. To be more precise, the latching means 28c is arranged on the side walls 34c of the main end cap body 12c. The latching means 28c is intended to fix a further wiper blade component 26c. In this exemplary embodiment, the latching means 28c is intended to fix the spring rail 24c. The latching means 28c is configured to be deflectable perpendicularly to a deflection direction 32c of the wiper strip fastening means 14c. To be more precise, the latching means 28c is configured to be deflectable in a wiping direction 82c.

In FIG. 11, the wiper strip 18c has been inserted into the main end cap body 12c. When the head strip recess 58c is reached, the wiper strip fastening means 14c moves elastically back into the starting position and in the process engages in the head strip recess 58c, as shown in FIG. 11. A free end of the wiper strip 18c is now held by the holding claws 62c, 64c of the end cap device. The wiper strip 18c is thus intended to be coupled with the wiper strip fastening means 14c in the assembled state.

The wiper strip fastening means 14c forms a spring rail abutment means 22c. The spring rail abutment means 22c is intended to block the wiper strip fastening means 14c upon abutment of the spring rail 24c. The spring rail abutment means 22c is formed integrally with the wiper strip fastening means 14c. To this end, the spring rail abutment means 22c forms an abutment surface 90c that is remote from the wiper lip. The abutment surface 90c is intended for the abutment of the spring rail 24c. The abutment surface 90c is configured in a planar manner. The spring rail abutment means 22c of the wiper strip fastening means 14c forms an extension of the spring rail abutment surface 38c of the main end cap body 12c.

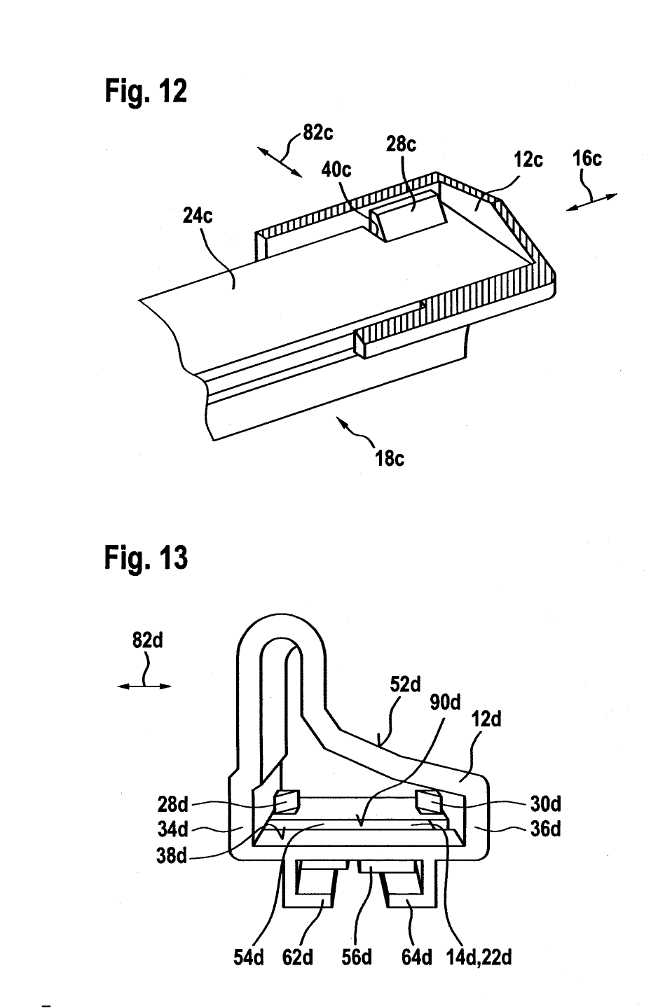

In order to prevent the wiper strip fastening means 14c from pivoting back, the spring rail 24c is pushed over the spring rail abutment means 22c. Once the spring rail 24c has been pushed in as far as possible, it is rotated slightly, wherein the latching means 28c latches in the latching recess 40c (FIG. 12). This prevents the wiper strip 18c from moving back from the main end cap body 12c. In the process, the spring rail 24c also comes into abutment with the abutment surface 90c. The spring rail 24c is thus intended to block the wiper strip fastening means 14c in the assembled state.

FIGS. 13 to 16 show a further exemplary embodiment of an end cap device. The end cap device has a main end cap body 12d. The main end cap body 12d has a concave wind deflection surface 52d. The end cap device has a wiper strip fastening means 14d. The wiper strip fastening means 14d is arranged on the main end cap body 12d. To be more precise, the wiper strip fastening means 14d is formed integrally with the main end cap body 12d. The wiper strip fastening means 14d is connected to a side wall 34d of the main end cap body 12d. To be more precise, the wiper strip fastening means 14d is connected integrally to the side wall 34d of the main end cap body 12d. Starting from the side wall 34d, the wiper strip fastening means 14d extends substantially in the direction of a further side wall 36d of the main end cap body 12d.

The wiper strip fastening means 14d is intended to fix the end main end cap body 12d in the wiper strip longitudinal direction 16d relative to a wiper strip 18d. In order to receive the wiper strip 18d, the end cap device has two holding claws 62d, 64d. A top side of the holding claws 62d, 64d forms a spring rail abutment surface 38d. In the assembled state, a spring rail 24d bears against the spring rail abutment surface 38d.

The wiper strip fastening means 14d has an elastically deflectable holding arm 54d. The holding arm 54d extends perpendicularly to the side wall 34d. The holding arm 54d has a rectangular cross section. Integrally formed on the holding arm 54d is an engagement element 56d. The engagement element 56d is formed in a cuboidal manner. The engagement element 56d is intended to engage in a corresponding head strip recess 58d in a head strip 60d of the wiper strip 18d. The wiper strip fastening means 14d is configured to be deflectable in a vertical direction 20d for assembly with the wiper strip 18d. To be more precise, the wiper strip fastening means 14d is configured to be movable in the direction of the wind deflection surface 52d during assembly. The wiper strip fastening means 14d is arranged in a manner offset in the wiper strip longitudinal direction 16d relative to the holding claws 62d, 64d. The wiper strip fastening means 14d is arranged in front of a receiving region of the holding claws 62d, 64d in an unstressed starting position. The vertical direction 20d extends perpendicularly to a wiping plane across which the wiper strip 18d scrapes during operation.

The end cap device also has two latching means 28d, 30d. The latching means 28d, 30d are formed regionally in a barb-like manner. The latching means 28d, 30d are arranged on the main end cap body 12d. To be more precise, the latching means 28d, 30d are arranged on the side walls 34d, 36d of the main end cap body 12d. The latching means 28d, 30d are intended to fix a further wiper blade component 26d. In this exemplary embodiment, the latching means 28d, 30d are intended to fix the spring rail 24d. The latching means 28d, 30d are configured to be deflectable perpendicularly to a deflection direction 32d of the wiper strip fastening means 14d. To be more precise, the latching means 28d, 30d are configured to be deflectable in a wiping direction 82d. The latching means 28d, 30d are arranged in front of the wiper strip fastening means 14d, as viewed in an insertion direction 96d of the wiper strip 18d.

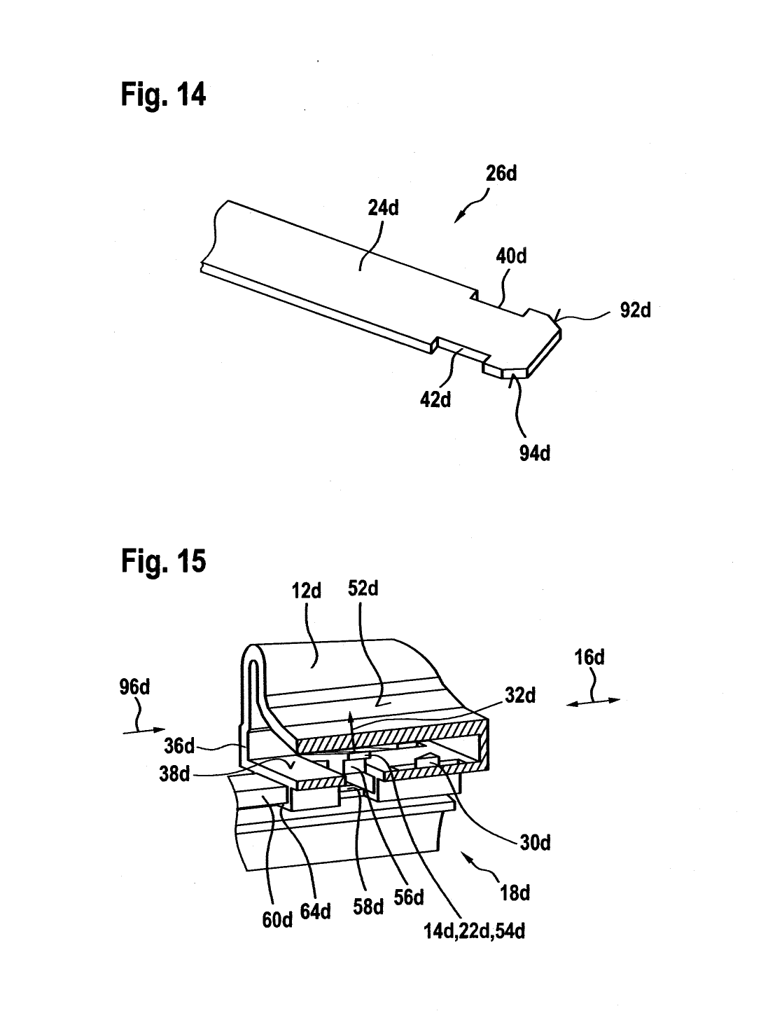

Latching recesses 40d, 42d are arranged in the spring rail 24d (FIG. 14). The latching means 28d, 30d of the end cap device engage in the latching recesses 40d, 42d in the spring rail 24d in an assembled state. Furthermore, chamfered faces 92d, 94d are arranged at a free end of the spring rail 24d, said chamfered faces 92d, 94d being intended to deflect the latching means 28d, 30d during assembly. The chamfered faces 92d, 94d extend at a 45°-angle relative to the wiper strip longitudinal direction 16d in the assembled state.

In FIG. 15, the holding arm 54d has been elastically deflected. The end cap device is pushed onto the wiper strip 18d. A wind deflector unit is not illustrated here for reasons of clarity, although it is likewise pushed into the end cap device. Once an end position has been reached, the wiper strip fastening means 14d moves into the head strip recess 58d. A free end of the wiper strip 18d is now held by the holding claws 62d, 64d of the end cap device. The wiper strip 18d is thus intended to be coupled with the wiper strip fastening means 14d in the mounted state.

The wiper strip fastening means 14d forms a spring rail abutment means 22d. The spring rail abutment means 22d is intended to block the wiper strip fastening means 14d upon abutment of the spring rail 24d. The spring rail abutment means 22b is formed integrally with the wiper strip fastening means 14d. To this end, the wiper strip abutment means 22d forms an abutment surface 90d that is remote from the wiper lip. The abutment surface 90d is intended for the abutment of the spring rail 24d. The abutment surface 90d is configured in a planar manner. The spring rail abutment means 22d of the wiper strip fastening means 14d forms an extension of the spring rail abutment surface 38d of the main end cap body 12d.

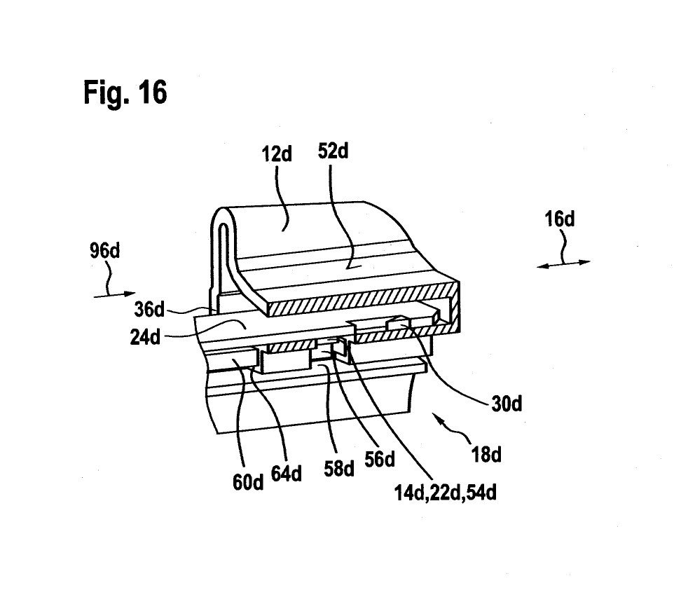

In order to prevent the wiper strip fastening means 14d from pivoting back, the spring rail 24d is pushed over the spring rail abutment means 22d (FIG. 16). There, the spring rail 24d comes into abutment with the abutment surface 90d. The spring rail 24d is thus intended to block the wiper strip fastening means 14d in the assembled state. The wind deflector unit is pushed into the end cap device until the latching means 28d, 30d of the end cap device engage in the latching recesses 74d, 76d. The wiper strip 18d is thus prevented from moving back from the main end cap body 12d.

What is claimed is:

1. An end cap device for a wiper blade (10a), the device comprising a main end cap body (12a-12d) and at least one wiper strip fastening means (14a; 14c; 14d) which is arranged on the main end cap body (12a-12d) and which is configured to fix the main end cap body (12a-12d) in a wiper strip longitudinal direction (16a; 16c; 16d) relative to a wiper strip (18a; 18c; 18d), characterized in that the at least one wiper strip fastening means (14a; 14c; 14d) is configured to be deflectable in a vertical direction (20a; 20c; 20d) for assembly with the wiper strip (18a; 18c; 18d).

2. The end cap device according to claim 1, characterized in that the at least one wiper strip fastening means (14a; 14c; 14d) forms a spring rail abutment means (22a; 22c; 22d) which is configured to block the at least one wiper strip fastening means (14a; 14c; 14d) upon abutment of at least a spring rail (24a-24d).

3. The end cap device according to claim 1, further comprising at least one latching means (28a; 28c; 28d, 30a; 30d) which is arranged on the main end cap body (12a-12d) and is configured to fix at least one further wiper blade component (26a; 26c; 26d).

4. The end cap device according to claim 3, characterized in that the at least one latching means (28a; 28c; 28d, 30a; 30d) is configured to be deflectable at least substantially perpendicularly to a deflection direction (32a; 32c; 32d) of the at least one wiper strip fastening means (14a; 14c; 14d).

5. The end cap device according to claim 1, characterized in that the at least one wiper strip fastening means (14a; 14c; 14d) is connected to a side wall (34a; 34c; 34d) of the main end cap body (12a-12d).

6. The end cap device according to claim 3, characterized in that the at least one latching means (28a; 28c; 28d, 30a; 30d) is arranged on a side wall (34a; 34c; 34d) of the main end cap body (12a-12d).

7. The end cap device at least according to claim 2, characterized in that the spring rail abutment means (22a; 22c; 22d) of the at least one wiper strip fastening means (14a; 14c; 14d) forms an extension of a spring rail abutment surface (38a; 38c; 38d) of the main end cap body (12a-12d).

8. A system having an end cap device according to claim 1 and having at least one spring rail (24a-24d) which is configured to block the at least one wiper strip fastening means (14a; 14c; 14d) in an assembled state.

9. A system having an end cap device according to claim 3 and having at least one spring rail (24a-24d) which is configured to block the at least one wiper strip fastening means (14a; 14c; 14d) in an assembled state, wherein the spring rail (24a-24d) has at least one latching recess (40b-40d, 42b; 42d) which is configured for coupling with the at least one latching means (28a; 28c; 28d, 30a; 30d).

10. The system according to claim 8, characterized by a wiper strip (18a; 18c; 18d) which is configured to be coupled with the at least one wiper strip fastening means (14a; 14c; 14d) in an assembled state.

11. The system according to claim 9, characterized by a wiper strip (18a; 18c; 18d) which is configured to be coupled with the at least one wiper strip fastening means (14a; 14c; 14d) in an assembled state.

12. A wiper blade (10a) comprising a wiper strip and a system according to claim 8.

13. A wiper blade (10a) comprising a wiper strip and a system according to claim 9.

14. A wiper blade (10a) comprising a wiper strip and a system according to claim 10.

15. A wiper blade (10a) comprising a wiper strip and a system according to claim 11.
